(19) United States
(12) Patent Application Publication
(10) Pub. No.: US 2001/0034818 A1
(43) Pub. Date: Oct. 25, 2001

(54) Method for linking program modules reloaded into a main memory of a processor on a smart card

(76) Inventors: Christian May, Munchen (DE); Jurgen Freiwald, Hohenkirchen (DE); Olaf Brixel, Munhen (DE)

Correspondence Address: LERNER AND GREENBERG, P.A., Post Office Box 2480, Hollywood, FL, 33022-2480, US

(21) Appl. No.: 09/798,105

(22) Filed: Mar. 2, 2001

Related U.S. Application Data
(63) Continuation of application No. PCT/DE99/02784, filed on Sep. 2, 1999.

(30) Foreign Application Priority Data
Sep. 2, 1998 (DE) 198 40 029.2

(51) Int. Cl. G06F 12/00

(52) U.S. Cl. 711/151; 711/154

(57) ABSTRACT

Method for linking reloaded program modules on a smart card with likewise reloaded libraries, in which the method is split into two portions. The first portion can be carried out at any instant after the program module has been compiled. Only the second portion, in which the dynamic references are resolved, needs to take place after the program modules have been loaded on the smart card.

### CROSS-REFERENCE TO RELATED APPLICATION

This application is a continuation of copending International Application No. PCT/DE99/02784, filed Sep. 2, 1999, which designated the United States.

### BACKGROUND OF THE INVENTION

1. Field of the Invention

The present invention relates to a method for linking program modules reloaded into a main memory of a processor, for example on a smart card. The invention is concerned with the following problem area: On future multi-application smart cards, the user will be able

to reload not only the statically preloaded operating system and standard libraries, but also individual program modules. This has not been possible to date for the following reason: each program is based on addresses which positions the program is executed. A so-called “linker” stipulates this address allocation. Since, for the program which is to be reloaded, the addresses already used in the smart card are entirely unknown, it is necessary to provide the option of being able to execute programs which are to be reloaded at arbitrary addresses; i.e. the programs which are to be reloaded must be capable of being relocated on the smart card. It is to be expected that the sum of reloadable modules will exceed the physical address area available on the smart card. The modules cannot therefore be allocated a firmly prescribed physical address area. The operating system on the card must therefore be able to allocate a free memory area to a module dynamically when loading the module onto the card. To this end, a module which is to be reloaded must inform the smart card of which libraries it needs to access. Once it has been verified that the module is entitled to access the appropriate libraries, the module needs to be linked to these libraries, i.e. provided with the appropriate logical addresses for the access operations. Logical addresses are managed by the operating system on the card and can be uniquely associated with physical addresses. If all libraries are on defined address areas, the new module may be statically linked in advance and transferred to the smart card unmodified. However, should a library, for its part, be located on a dynamically assigned address area, then the new module must be dynamically linked to this library, i.e. the new module needs to be provided with the currently valid logical addresses of the library. Thus, during programming, the new module contains only the name of the library and the appropriate symbolic segment references, and also, if appropriate, other references which will be accessed. During the link operation, these references then need to be replaced with the currently valid logical addresses, in particular those of the appropriate segments of the library.

In principle, the link operation can take place either in the card terminal or on the smart card. The former case is regarded as being too unreliable, since it is necessary to ensure that the terminal has not been manipulated. In addition, the data may be manipulated again on the communication link between the terminal and the card.

Since the newly dynamically linked module has, in principle, been modified from its state before the link operation, because of the fact that the symbol references had to be resolved during the link operation, it is also not possible to check a statically predefined signature of the program in the smart card. The only reliable way is to move the linker to the smart card. The problem with this, however, is that the conventional link strategy, in which a relatively complex parser reads the object code and satisfies dynamic references, requires too many memory resources on the card. Previously, there was no solution to this problem in the prior art. It has therefore not been possible to date with a reasonable amount of effort to use libraries on dynamically assigned address areas on a sufficiently reliable smart card.

The closest prior art in this area is found in Published German Patent Application DE 197 23 676 A1. This document likewise describes a method for reloading programs onto a smart card. Based on this prior art, it is admittedly possible for programs to be distributed dynamically over appropriate program banks. However, this method does not permit a dynamically reloaded program to access another dynamically reloaded program or a dynamically reloaded address, since, based on this prior art, only the jump addresses within a program can be recalculated and matched. Hence, this prior art also fails to achieve the object of permitting reloadable applications to access libraries which are likewise stored on dynamically assigned address areas.

International Publication WO 97/24674 discloses a so-called “Home Communication Terminal”, in which the existing shortage of main memory means that programs loaded into the terminal in compressed form are transferred into the main memory only to the extent that there is a main memory.

A similar situation, just for computer systems, is disclosed in International Publication WO 94/22078.

### SUMMARY OF THE INVENTION

It is accordingly an object of the invention to provide a method which overcomes the above-mentioned disadvantageous of the prior art methods of this general type. In particular, it is an object of the invention to provide a method in which reloadable applications can access libraries located on dynamically assigned address areas without reliability problems arising as a result of a moved link operation, for example, taking place in the card terminal.

The invention achieves this object by virtue of the fact that the link operation is split into two portions. The first portion can be carried out at any instant after the program module has been compiled. Only the second portion, in which the symbol references are resolved, needs to take place after the program modules have been loaded.

With the foregoing and other objects in view there is provided, in accordance with the invention a method for linking program modules reloaded into a main memory of a processor on a smart card, that includes steps of: splitting a process for linking a program module into a first portion and a second portion; performing the first portion of the process at any instant of time after the program module has been compiled; resolving symbol references in the second portion of the process; and after the program module has been loaded into a main memory of a processor of a smart card, performing only the second portion of the process.

In accordance with an added feature of the invention, to save additional resources, it is particularly advantages to have the dynamic references resolved by a simple machine.

In accordance with an additional feature of the invention, a particularly simple program structure is obtained if the first portion of the method generates an object file with a header containing the information about the libraries and their segments to which links are to be produced.

In accordance with another feature of the invention, another particular preference is that the header of the object file additionally contains the information about those dynamic references which are used in the actual object code.

In accordance with a further feature of the invention, particularly simple processing on the card is obtained when the actual object code is broken down into a sequence of blocks. The beginning of each block holds the information about how many bytes of the object code can be read in before the first symbol reference appears. Each block ends with the symbol reference.

In accordance with a further added feature of the invention, particularly simple processing is also obtained by virtue of the fact that the header of the object code is stored in the main memory at the start of the second portion of the link operation, and the actual addresses on the card are allocated there to the dynamic references.

In accordance with a concomitant feature of the invention, a particularly simple link operation is obtained if, during the second portion of the link operation on the card, in each case, the beginning of the block is read in, the number of bytes which can be read in without converting a dynamic reference is stored, and the block, without the beginning of the block, is then read into the memory on the card. At the end of the block, instead of the dynamic reference, the actual address on the card is read in from the converted header of the object code.

Other features which are considered as characteristic for the invention are set forth in the appended claims.

Although the invention is illustrated and described herein as embodied in a method for linking program modules reloaded into a main memory of a processor on a smart card, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows the structure of the object file, as produced after the first portion of the link method according to the invention;

FIG. 2 shows the state of the program after the references in the object code header have been converted into the absolute addresses, with a reference list having been created;

FIG. 3 shows the state of the program after conversion of the references in the object code header, with a reference stack having been produced;

FIG. 4 shows the state of the program after conversion of the references, with a position list having been created; and

FIG. 5 shows the state of the program after conversion of the references, with the addresses having been replaced.

### DESCRIPTION OF THE PREFERRED EMBODIMENTS

In the described illustrative embodiment of the invention, program modules are dynamically reloaded on a smart card. In this case, the complex part of the linker needs to be split off and removed from the card. In the card itself, there is just a simple machine operating, which deals with the resolution of the symbol references. The linker on the card is adequately described by the new link format of the object files:

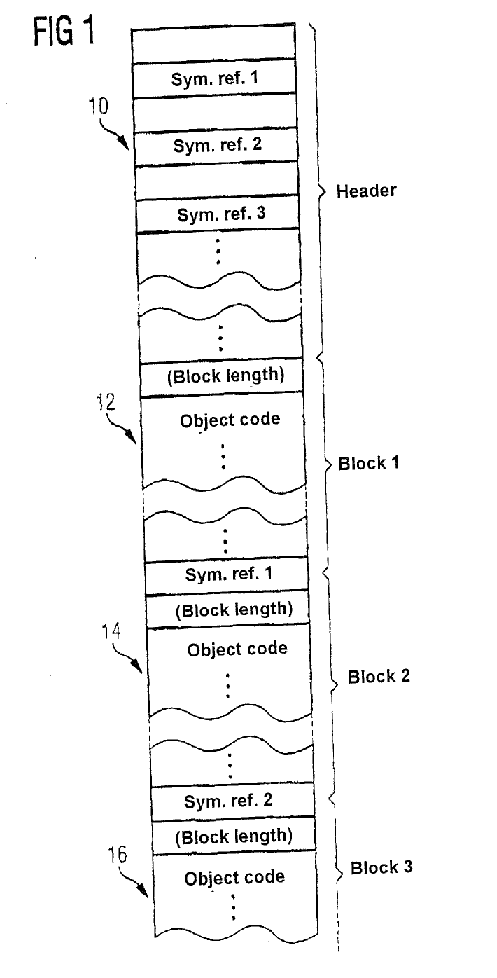

Referring now to the figures of the drawing in detail and first, particularly, to FIG. 1 thereof, there is shown an object file. The header 10 of the object file contains information about libraries and their segments to which links are to be produced. The header also contains the appropriate symbol references used in the actual object code. The actual object code, then, is a sequence of blocks 12, 14, 16. The beggining of a block holds information about the number of bytes of the program code which can be read in before the first dynamic reference appears. This reference ends the block. The corresponding structure of the object file, as transferred to the smart card, is shown in FIG. 1. The object file includes a header 10 which in each case contains the name of the respective library, and of the respective segment to which links are to be produced and the associated symbol reference.

This object header is followed by the individual blocks of the object code. The block length is always indicated at the beginning of the block, and each block ends with a symbol reference. Such an object code structured as shown in FIG. 1 can be created at any desired instant after the program has been compiled, and on any desired computer.

Only the second portion of the link operation need take place on the smart card:

The linker on the card reads in the object header and allocates, to the symbol references, the actual addresses on the card. Provided that few symbol references are frequently required in the object code, it is worthwhile applying an allocation table of symbol references to the actual addresses. This information must then be present during the entire link operation. If a multiplicity of dynamic references are only relatively rarely called in the object code, it is possible to simplify the link operation further by configuring the symbol references in the header 10 of the object code in the order in which they appear in the object code. In this case, the address at which a substitution is to be made can also be indicated directly in the object code. The block structure is then dispensed with. Another option of interest is to specify the name and the symbol reference directly at the end of a block, with the symbol reference then being resolved each time. After conversion on the card to the actual physical addresses, the header 10 then contains a list of the absolute addresses in the order in which they need to be incorporated into the object code. There is no need to replace the header for this purpose. It is sufficient for an appropriate list to be held in the memory. This list can be erased after loading, which saves a considerable amount of memory space.

After this address table or address list has been produced, in each case, the beginning of a block is read in and the number of bytes which can be read in without converting a symbol reference to the program segment is stored. The beginning of the block (which, of course, indicates only the number of bytes in this block) is not transferred to the program code at the same time in this context. At the end of the block, the symbol reference is replaced with the actual current address. To this end, either the comparison table in the object code header 10 is used, or the physical address associated with this block is simply called from an appropriate list. In the case of the latter organization, the header can also be organized in the form of a stack.

The next block can then be executed.

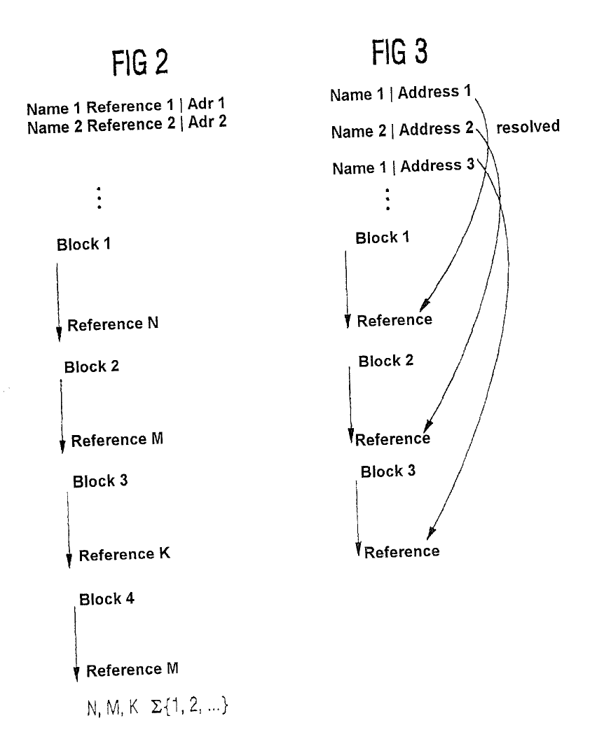

FIGS. 2 to 5 show the object code after conversion of the dynamic references in the header 10. In this context, the absolute addresses can either be organized in the form of a table, in which case appropriate reference numbers (1, 2, 3) are used for allocation to the respective dynamic references in the object code, or the header can, like a stack, contain the absolute addresses in the order in which they are required by the blocks.

Specifically, FIG. 2 shows an inventive solution in which the object code header is used to produce a list respectively containing the names and references and also the respective actual current addresses. This means that only a very small table is produced which requires very little memory space when only a few references occur in the program very often. This is shown by way of example in the figure by the repeated appearance of the reference M.

FIG. 3 shows an inventive solution where the object code header is organized in the form of a stack containing the addresses in the order in which they appear in the object code. In this case, the loading operation is simplified further, since the topmost address needs to be copied in from the stack only after each block.

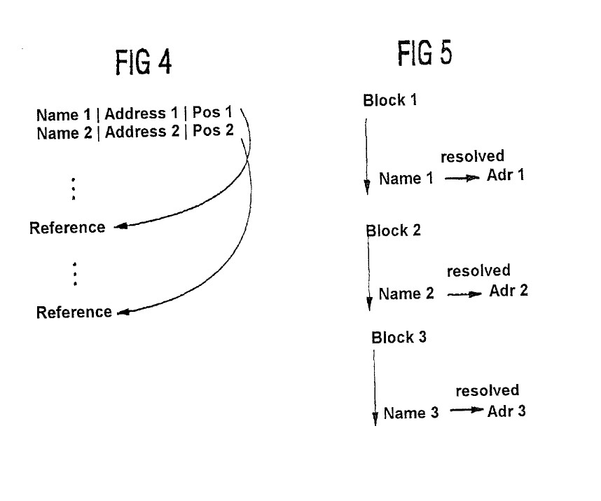

FIG. 4 shows an inventive solution where a table is stored which contains not only the name and address but also the respective positions at which the respective symbol reference needs to be replaced with the actual current address. This table can then also be configured at the end of the object code. This configuration is of even more benefit to execution, since the table then need not be held in memory, but rather can be processed gradually only when the object code has been loaded into the memory.

FIG. 5 shows an inventive solution in which the addresses are resolved directly.

A common feature of all of these inventive solutions is that the symbol references are replaced with the actual current address once while the program is loaded onto the card, and not at the time at which the program is executed. The symbol references are thus resolved only once during loading. The memory therefore does not continuously have to hold the lists containing the allocation of symbol references to actual current addresses, which results in a considerable memory saving. According to the inventive concept, the linker is thus split into a complex prelinker which can be executed immediately after the program has been compiled. After the prelink process, the code can be signed. The signed code is linked and verified in the linker on the card during reading in. In this context, the entry “name n” in FIGS. 2 to 4 may possibly also be dispensed with, provided that the addresses are unique.

The present invention permits libraries and applications accessing these libraries to be reloaded reliably for the first time. Without it, it would be possible to reload only applications dynamically. As an example, the invention provides the following application to be performed: The kernel and the operating system are statically linked on the smart card. The user would now like to load IATA (Internation air Transport Association), a library for all airlines, onto the card dynamically and then also reload a bonus point application for a specific airline, which accesses the IATA library.

We claim:

1. A method for linking program modules reloaded into a main memory of a processor on a smart card, which comprises:
splitting a process for linking a program module into a first portion and a second portion;
performing the first portion of the process at any instant of time after the program module has been compiled;
resolving symbol references in the second portion of the process; and
after the program module has been loaded into a main memory of a processor of a smart card, performing only the second portion of the process.

2. The method according to claim 1, which comprises performing the step of resolving the symbol references with a simple machine.

3. The method according to claim 1, which comprises, in the first portion of the process, generating an object file with a header including information about libraries and segments of the libraries to which links are to be produced.

4. The method according to claim 3, which comprises, including in the header of the object file, information about specific ones of the symbol references that are used in an actual object code.

5. The method according to claim 4, which comprises:
breaking down the object code into a sequence of a plurality of blocks;
providing each one of the plurality of the blocks with a beginning and an end;
providing, at the beginning of each one of the plurality of the blocks, information about a number of bytes of the object code that can be read in before a respective first one of the symbol references appears; and
providing, at the end of each one of the plurality of the blocks, the respective first one of the symbol references.

6. The method according to claim 5, which comprises:
at a beginning of the second portion of the process, storing a header of the object code in the main memory; and
in the header of the object code, allocating actual addresses to the symbol references.

7. The method according to claim 6, which comprises, during the second portion of the process, for each one of the plurality of the blocks:
reading in the beginning of a respective one of the plurality of the blocks;
storing the information about the number of the bytes of the object code that can be read in before the respective first one of the symbol references appears;
reading the respective one of the plurality of the blocks into the main memory without reading the beginning thereof into the main memory; and
at the end of the respective one of the plurality of the blocks, instead of the respective one of the symbol references, reading in one of the actual addressess in the main memory from the header of the object code.
